(19) United States
(12) Patent Application Publication
(10) Pub. No.: US 2013/0091715 A1
(43) Pub. Date: Apr. 18, 2013

(54) HANDHELD WORK APPARATUS HAVING A GUARD

(71) Applicant: Andreas Stihl AG & Co. KG, Waiblingen (DE)

(72) Inventors: Helmut Zimmermann, Berglen (DE); Jonas Lank, Korb (DE)

(73) Assignee: ANDREAS STIHL AG & CO. KG, Waiblingen (DE)

(21) Appl. No.: 13/649,661

(22) Filed: Oct. 11, 2012

(30) Foreign Application Priority Data
Oct. 12, 2011 (DE) 10 2011 115 720.8

(51) Int. Cl. B28D 1/08; B26B 27/00; B26B 29/00

(52) U.S. Cl. 30/382; 30/277.4; 125/21

(57) ABSTRACT

A handheld work apparatus such as a stone cutter (1) having a housing (2) in which a drive motor (5) is arranged. The work apparatus has a tool driven by the drive motor (5) for cutting mineral or metallic materials. The housing (2) has a housing front end (16) facing the workpiece to be cut and arranged adjacent to the workpiece. The tool projects beyond the housing front end (16). In order to avoid damage on the housing front end (16), it is provided that an elastic guard (17, 47), which extends over at least 50% of the width (b) of the housing front end (16), is arranged on the housing front end (16).

### CROSS REFERENCE TO RELATED APPLICATION

This application claims priority of German patent application no. 10 2011 115 720.8, filed Oct. 12, 2011, the entire content of which is incorporated herein by reference.

### BACKGROUND OF THE INVENTION

U.S. Pat. No. 6,186,136 discloses a handheld work apparatus, namely a stone cutter, which has a saw chain for cutting stone. The saw chain is arranged on a guide bar which is fixed to a housing and projects forward from the housing.

It has been shown that the housing front end can strike the stone hard during operation. In order to achieve sufficient stability for the housing in this frontal region, the housing must be made with thick walls, which leads to a high weight of the stone cutter.

### SUMMARY OF THE INVENTION

It is an object of the invention to provide a handheld work apparatus of the generic type which has a robust construction and a low weight.

The handheld work apparatus of the invention includes: a housing having a housing front end having a width (b); a drive motor arranged in the housing; a tool for cutting at least one of mineral materials and metal materials; the housing front end being configured to face a workpiece to be cut and to be arranged adjacent to the workpiece during a cutting process; the tool being disposed so as to project beyond the housing front end; an elastic guard arranged on the housing front end and extending over at least 50% of the housing front end.

During operation, the housing front end can rest on the workpiece, for example on the stone, roll on the workpiece, or slide on the workpiece. The elastic guard protects the housing front end from mechanical stresses in the process. Because of its elasticity, the guard acts as a shock absorber. As a result, the housing front end can be constructed with a conventional wall thickness without reinforcements. The elastic guard has a low weight in comparison with a reinforced configuration of the housing front end. As a result of its elasticity, the guard is resistant to bumps and scratches thereby resulting in a robust configuration. The guard extends over at least 50%, in particular over at least 80%, and advantageously over the entire width of the housing front end, so that the majority of the housing front end is protected from mechanical damage. As a result, wearing of the housing parts, which have a complex structure and are thus expensive, is avoided. Housing here refers to components which at least partially delimit the space in which the drive motor is arranged. Cover or other add-on components on the housing, which have a simple structure and can be easily detached from the housing and are thus advantageously exchangeable, are not considered part of the housing. Parts of the drive motor itself, such as for example an exhaust muffler or the like, are also not viewed as housing parts. The housing front end refers to that region of the housing which lies adjacent to the workpiece and which can come into contact with the workpiece during operation. Set back regions of the housing, which in the case of a flat workpiece surface cannot come into contact with the workpiece, are not considered part of the housing front end.

The tool of the handheld work apparatus is suited for cutting mineral materials such as stone, concrete or the like and for cutting metallic materials such as metal pipes, metallic reinforcements in concrete or the like. The work apparatus is, in particular, a stone cutter which can be configured in a similar manner to a chain saw. The tool of the work apparatus is advantageously a saw chain arranged on a guide bar and driven in circulation. The tool of the work apparatus can, however, also be a cutting disk or the like.

The guard extends advantageously over the entire surface of the housing front end. A configuration of the guard with interruptions, for example a grid-like structure or a configuration of the guard as individual knobs which are arranged in a manner distributed over the entire housing front end, is also possible. Advantageously, the guard substantially covers the housing front end, and in particular completely covers the housing front end. As a result, even in the case of an irregular contour of the workpiece, contact with the housing front end and thus damage to the housing front end can be avoided. Because of the substantial, in particular complete covering of the housing front end, a closed, appealing configuration of the housing front end of the work apparatus results.

Work apparatuses for cutting mineral and metallic materials such as stone cutters operate with water. The water combines with the stone dust and/or metal dust to form sludge. In order to avoid excessive soiling of the housing, a spray guard section is provided. The spray guard section is advantageously formed on the guard. This results in a simple configuration. The spray guard section extends advantageously in the region below the tool, especially below the guide bar of the work apparatus configured as a stone cutter. In the case of a stone cutter, excessive soiling in the region of a chain sprocket cover of the stone cutter is avoided because of the spray guard section.

A simple configuration results when the guard is fixed on the housing of the work apparatus in a form-fitting manner. Advantageously, the housing has two longitudinal sides which are arranged opposite each other, wherein the guard is held on the housing in a form-fitting manner on both longitudinal sides. As a result, fixation without additional fastening elements and in particular tool-free assembly and disassembly is possible. In particular, a strut of the holding section engages behind a wall section of the housing in the direction of the housing front end. The guard is in this case advantageously held exclusively in the region of the longitudinal sides of the housing of the work apparatus and not at the housing front end. Because of the form-fitting fixation, the guard can be easily exchanged in the case of wear. The work apparatus is advantageously a stone cutter which has a guide bar on which a saw chain is driven in circulation. The stone cutter advantageously has a side plate arranged between the housing and the guide bar. The side plate serves to guide the saw chain. Advantageously, the holding section is covered by the side plate. The side plate thus serves to secure the holding section. The holding section is arranged in particular in a depression in the housing the depression being accessible from the side facing the side plate.

In order to securely define the position of the guard on the housing front end, it is provided that the guard has at least one securing section which engages around a housing wall of the work apparatus on the side opposite the holding section. The securing section prevents the holding section from being able to unintentionally detach from the housing wall. For the form-fitting fixation, it is advantageously additionally or alternatively provided that the guard has a recess into which a housing protrusion projects. The housing protrusion advantageously extends approximately in extension of the housing front end on the longitudinal side facing away from guide bar.

A simple configuration results when the work apparatus is configured as a stone cutter and is constructed in a similar manner to a chain saw. Housing parts of the chain saw can thus also be used for the stone cutter. A lubrication oil tank is typically provided in chain saws. Because a stone cutter is not lubricated with oil but rather a separate supply of water takes place, the lubrication oil tank is not needed in a work apparatus such as a stone cutter. For this reason it is, in particular, provided for the inlet opening for the lubrication oil tank to be used for the fixation of the guard. However, a different housing opening can also be provided for the fixation of the guard. The guard is held in the housing opening in a form-fitting manner. The housing opening forms in particular an access to a housing interior, for example the lubrication oil tank when housing parts of a chain saw are used. The guard advantageously forms a retainer for a tool in the area of the housing opening and the housing interior forms a receiving space for a section of the tool. As a result, the lubrication oil tank can be used for receiving a section of the tool and the housing opening can be used for the fixation of the guard. The guard furthermore serves for the fixation of the tool via the retainer. The housing opening is in this case advantageously arranged on the longitudinal side of the housing facing away from the tool, in particular from the guide bar.

In chain saws, support via a claw on the wood to be sawn is typical. Such a claw is not suitable for support on stone or metal. In order nonetheless to allow for support on stone or metal, it is provided that the guard has a supporting section, on which a profile is formed, for resting on the workpiece. The profile is intended to prevent sliding on the workpiece. The profile is advantageously formed by a plurality of mutually adjacent elevations. The supporting section is expediently arranged adjacent to the guide bar so that a direct support results. The supporting section is in this case in particular configured in one piece with the guard and is integrally formed on the guard.

In order to compensate for unevennesses on the housing and to achieve an additional, adjustable damping effect, it is provided that the guard has, on its inner side which faces the housing, at least one rib for resting on the housing front end. The damping effect can be set via the height of the rib.

Advantageously, at least one attachment part, especially a chain sprocket cover, is fixed on the housing, with a front end of the attachment part arranged adjacent to the workpiece and facing the workpiece to be cut during the cutting process being at least partially covered by an elastic guard. The front end of the attachment part is, in particular, completely covered by the guard.

Advantageously, at least one guard of the work apparatus is made of an elastomer or rubber.

### BRIEF DESCRIPTION OF THE DRAWINGS

The invention will now be described with reference to the drawings wherein:

FIGS. 1 and 2 show perspective views of a stone cutter;

FIG. 3 shows a perspective view of the housing of the stone cutter;

FIGS. 4 and 5 show perspective views of the guard of the stone cutter;

FIG. 6 shows a perspective view of the housing of the stone cutter without a side plate;

FIGS. 7 and 8 show perspective views of the guard of the stone cutter;

FIG. 9 shows a side view of the stone cutter in the region of the front end without a side plate;

FIG. 10 shows a section along the line X-X in FIG. 9;

FIG. 11 shows a section through the housing of the stone cutter with a side plate at the height of the line XI-XI in FIG. 9;

FIG. 12 shows a section through the housing of the stone cutter with a side plate at the height of the line XII-XII in FIG. 9;

FIG. 13 shows a section along the line XIII-XIII in FIG. 9;

FIGS. 14 to 17 show perspective views of an embodiment of a guard of a stone cutter; and,

FIG. 18 shows a schematic view of the configuration of the stone cutter.

### DESCRIPTION OF THE PREFERRED EMBODIMENTS OF THE INVENTION

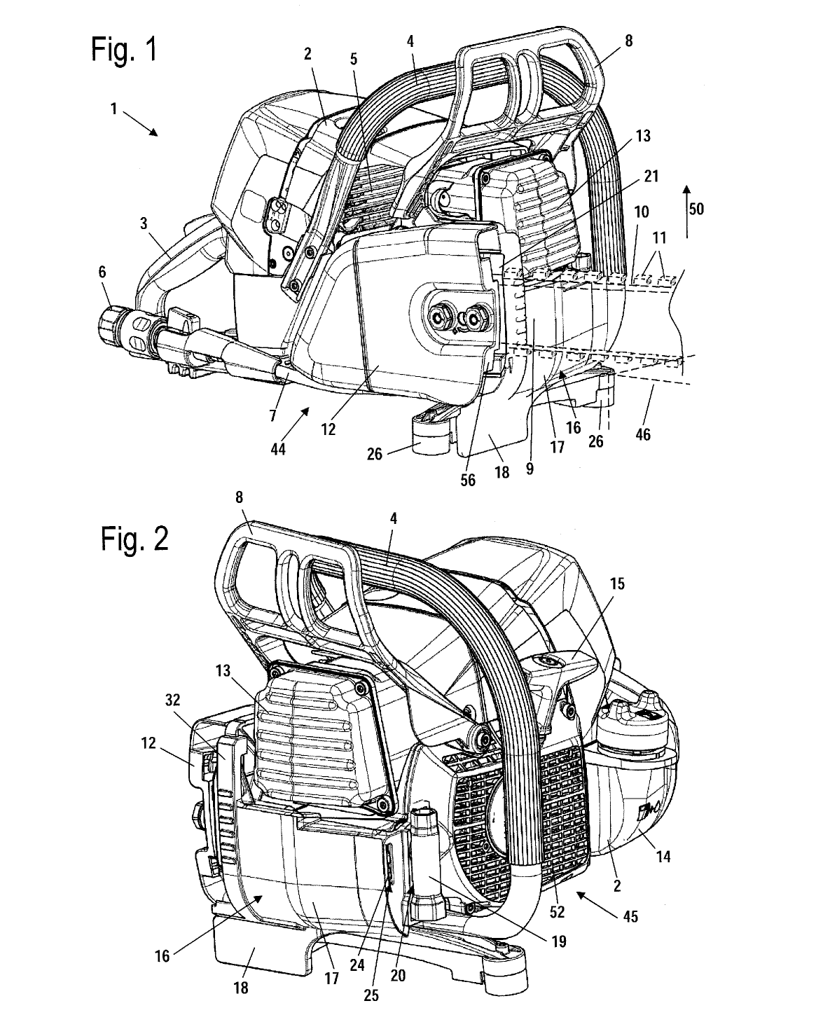

FIGS. 1 and 2 show a stone cutter 1, which is configured in a similar manner to a chain saw, as an exemplary embodiment of a handheld work apparatus. The work apparatus can also be a cut-off machine or the like. The stone cutter 1 has a housing 2 in which a drive motor 5 is arranged. A guide bar 9, which is shown schematically in FIG.1, is fixed on the housing 2. A saw chain 10, which is driven by the drive motor 5, is arranged around the periphery of the guide bar 9. The saw chain 10 has a multiplicity of cutting elements 11. Each element, which is suitable for severing metal and/or mineral materials such as stone, is referred to as a cutting element 11. The cutting element 11 can, in this case, also grind or sever in some other manner. The drive sprocket of the saw chain 10 is covered by a chain sprocket cover 12 which is fixed on the housing 2. The drive motor 5 is configured as a combustion engine, in particular a mixture lubricated combustion engine, and has a exhaust muffler 13 via which exhaust gases escape to the surrounding environment. The drive motor 5 can also be an electric motor which can, for example, be supplied with energy via a power cable or a battery, in particular a storage battery.

A back handle 3 and also a handle bar 4 are fixed on the housing 2. The back handle 3 is arranged on the side of the housing facing away from the exhaust muffler 13 and a front end 16 of the housing 2. The handle bar 4 spans over the housing 2 at a distance. A hand protector bracket 8, which is held tightly on the housing 2, is arranged in the region between the handle bar 4 and the guide bar 9. As FIG. 18 schematically shows, the stone cutter 1 has a motor housing 51 on which a handle housing 53 is fixed via anti-vibration elements 58. The handle housing 53 includes the back handle 3 and the handle bar 4 and also an outrigger 59 over which the motor housing 51 engages. The housing 2 is formed by the handle housing 53 and by the motor housing 51. Separate attachment parts which are fixed on the housing 2, such as the chain sprocket cover 12 shown in FIG. 1 or the fan wheel cover 52 shown in FIG. 2, do not constitute part of the housing 2. These components can be easily exchanged, whereas the exchanging of parts of the motor housing 51 or the handle housing 53 is complicated and expensive.

The saw chain 10 is supplied with water during operation. For this purpose, a water conduit 7 is provided which is to be connected to a unit for supplying water via a water connection 6. The water connection 6 is arranged in the region of the back handle 3. As FIG. 1 shows, the guide bar 9 is fixed on a first longitudinal side 44 of the housing 2, on which the water conduit 7 and the water connection 6 are also arranged. In order to set the stone cutter 1 on the ground, the stone cutter 1 has two support feet 26 which are arranged in the region of the housing front end 16. The housing front end 16 of the housing 2 is completely covered by a guard 17 which is made of an elastic material, such as for example rubber or an elastomer. A spray guard section 18 is provided on the guard 17, the spray guard section 18 extending downwardly from the housing front end 16 in the rest position of the stone cutter 1 shown in FIG. 1, and to the side into the region below the guide bar 9 and the entry of the saw chain 10 below the chain sprocket cover 12. The spray guard section 18 conveys the sludge formed of water and stone dust away downwardly and thus reduces the amount of sludge conveyed under the chain sprocket cover 12. In the rest position shown in FIG. 1, the spray guard 18 is at a small distance from the ground. As a result, the stone cutter 1 can be positioned stably on the ground or other rest surface with its support feet 26. The support feet 26 are configured correspondingly high and the spray guard section 18 is configured correspondingly short. In FIG. 1, a workpiece 46, namely a stone block to be cut, is shown schematically.

As shown in FIG. 2, the stone cutter 1 has a start handle 15, which serves to start the drive motor 5, projecting out of the housing 2 on the second longitudinal side 45 of the housing 2 which lies opposite the guide bar 9. A fuel tank 14 is integrated in the handle housing 53, as also shown in FIG. 18. As FIG. 2 shows, the guard 17 has a supporting section 32 adjacent to the chain sprocket cover 12 and the guide bar 9, the supporting section 32 extending in the vertical direction 50 (FIG. 1) of the stone cutter 1, that is to say parallel to the plane of the guide bar 9, over almost the entire height of the chain sprocket cover 12. In the rest position shown in FIG. 1, the vertical direction 50 is in the opposite direction to the effective direction of gravity. On the longitudinal side 45, the guard 17 has a cutout 25 into which a housing protrusion 24 projects and thus holds the guard 17 in a form-fitting manner in this region. The cutout 25 is configured as an opening. The housing protrusion 24 extends in extension of the housing front end 16 of the housing 2 and only projects a little beyond the cutout 25. The guard 17 has a retainer 20 for a tool 19 adjacent to the cutout 25.

As FIGS. 1 to 3 show, the guard 17 extends over the entire housing front end 16 and largely covers the latter. Both the entire width and the entire height of the housing 2 are covered by the guard 17 in the region of the housing front end 16. However, the guard 17 does not extend into the region of the exhaust muffler 13, but rather is at a distance therefrom. The exhaust muffler is made of metal and, for this reason, has a high strength in comparison to the housing 2 made of plastic, and so covering of the exhaust muffler 13 by the guard 17 is not necessary. Covering of the exhaust muffler 13 by the guard 17 would hinder the heat transfer from the exhaust muffler to the environment and is not provided for this reason. The chain sprocket cover 12, which is not part of the housing 2, is also not covered by the guard 17. In the exemplary embodiment, the guard 17 completely covers housing front end 16, that is, the region of the housing 2 which is adjacent to a workpiece 46. It can, however, be provided that the guard 17 extends over the entire width (b) of the housing front end 16 but does not extend over the entire height of the housing front end 16 everywhere. The width (b) of the housing front end is shown in FIG. 13. The guard 17 can be omitted in particular in the upper and lower edge regions of the housing front end 16 whereat no contact with stone can be expected. An interrupted configuration of the guard 17, for example, a rib or a knob structure can also be advantageous.

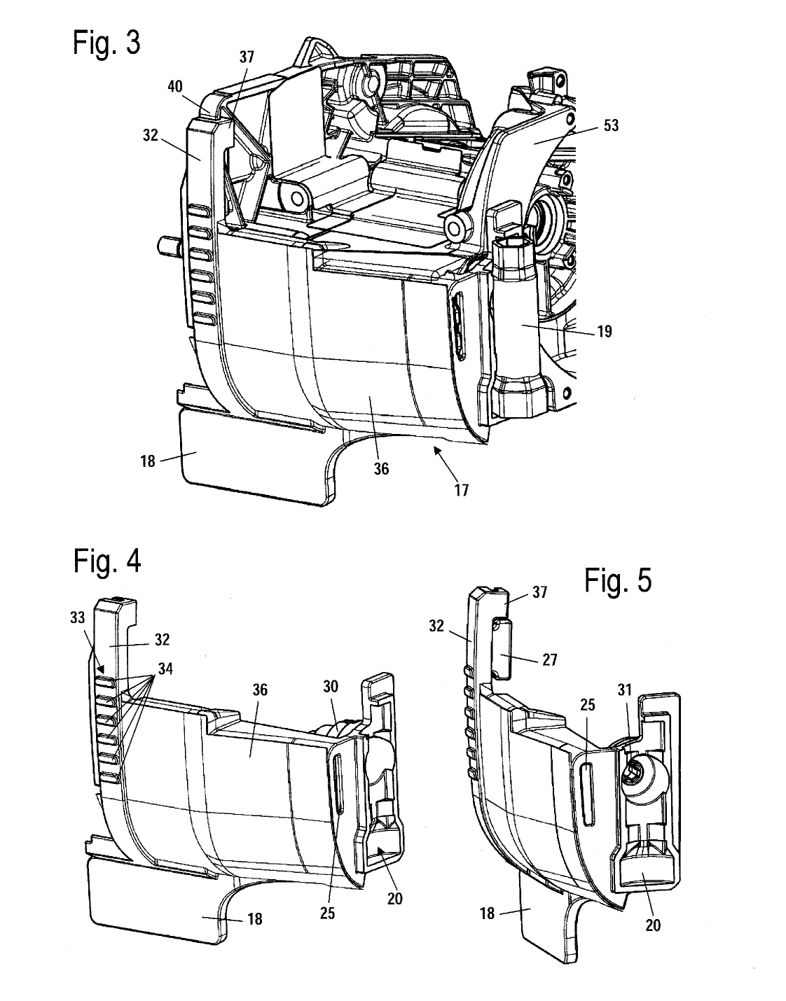

As FIG. 3 shows, a securing section 37, which reaches around a housing wall 40 on the side facing away from the longitudinal side 44, is integrally formed on the guard 17 in the upper region of the supporting section 32. The guard 17 has a covering section 36 which extends over the housing front end 16.

As FIG. 4 shows, a profile 33 consisting of a plurality of elevations 34 arranged at a distance from one another is integrally formed on the supporting section 32. The elevations 34 are configured as struts running perpendicular to the plane of the guide bar 9 and thus reduce the danger of the guard 17 sliding off in relation to the workpiece in the upward direction of the guide bar 10.

A plug 30 projects into the housing 2 at the inner side of the guard 17 adjacent to the retainer 20 for the tool 19. This is also shown in FIG. 13. The plug 30 projects into a housing opening 29 which connects the outer side of the housing with a housing interior space 28. The housing interior space is advantageously the lubrication oil tank when the housing 2 of a chain saw is used. This lubrication oil tank is not needed for the stone cutter 1. For this reason, it is provided for a tool 19 to be at least partially arranged in the housing interior space 28. The tool 19 projects into the housing interior space 28 through a plug-in opening 31 formed in the plug 30. As FIG. 5 shows, the plug-in opening 31 is profiled in order to achieve good fixation of the tool 19. The retainer 20 is furthermore formed in such a manner that the tool 19 is securely held in the retainer 20. In the embodiment, the tool 19 is a socket wrench which projects into the housing interior space 28 and on whose handle further wrenches or the like are formed. The handle is arranged in the retainer 20.

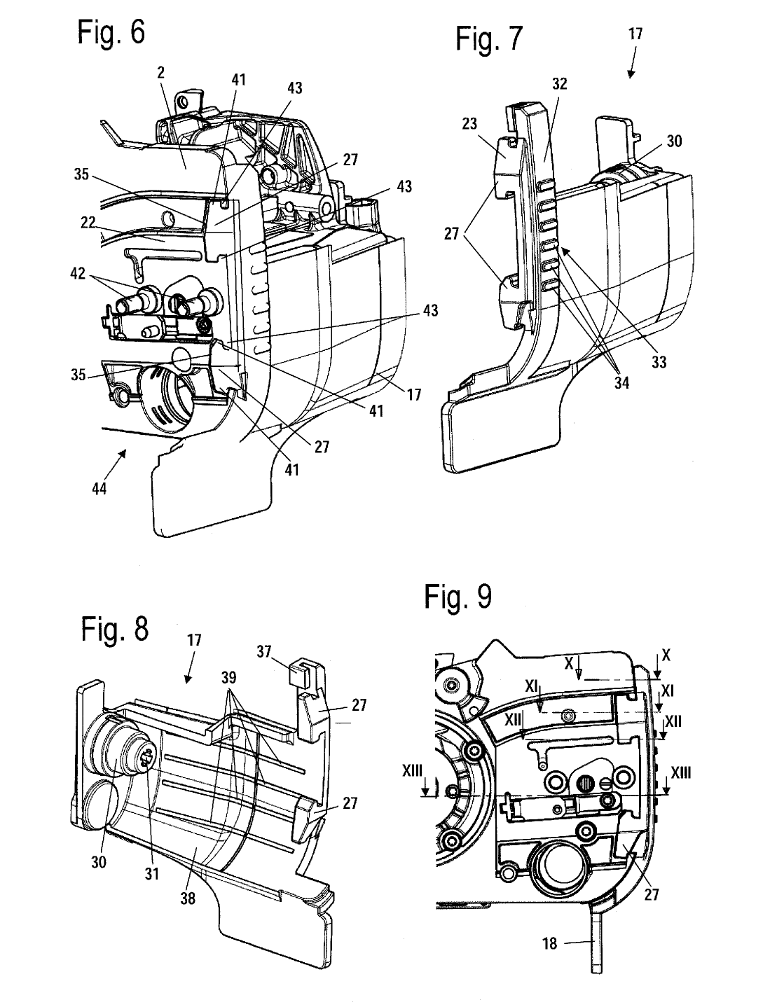

FIGS. 6 to 8 show the form-fitting fixation of the guard 17 on the longitudinal side 44 of the stone cutter 1. The guard 17 has two holding sections 27 on the longitudinal side 44, the holding sections 27 each having two struts 41 which project upward and downward. The holding sections 27 are arranged in depressions 35 on the housing, the contour of the depressions 35 corresponding to that of the holding sections 27. The struts 41 in this case engage behind wall sections 43 of the housing 2 and thus secure the guard 17 in a form-fitting manner in the direction of the housing front end 16. A corresponding form-fitting fixation can also be provided on the opposing longitudinal side 45 of the housing 2. The guard 17 can be fixed in a form-fitting manner on the housing 2 without tools. A tool is typically only needed for the mounting of the side plate 21 which serves to secure.

As FIG. 6 shows, the housing 2 has on the longitudinal side 44, a contact surface 22 for the side plate 21 shown in FIG. 1. The side plate 21 is configured for contacting the guide bar 9 and for guiding the saw chain 10. Two attachment bolts 42 for attaching the guide bar 9 to the housing 2 project through the side plate 21.

As FIG. 7 shows, the holding sections 27 have a contact surface 23 for the side plate 21, the contour of the contact surface 23 corresponding to the contour of the side plate 21. The side plate 21 closes the depressions 35 to the outside so that the holding sections 27 cannot escape laterally from the depressions 35. The guard 17 is held on the housing in a form-fitting manner via the holding sections 27 and is additionally secured by the side plate 21.

FIG. 8 shows the inner side 38 of the guard 17. On the inner side 38, the guard 17 in the embodiment 4 has ribs 39 which run approximately horizontally, that is perpendicular to the plane of the guide bar 9. The ribs 39 serve for contact engagement on the housing 2. The resulting damping effect of the guard 17 can be adjusted via the height of the ribs 39.

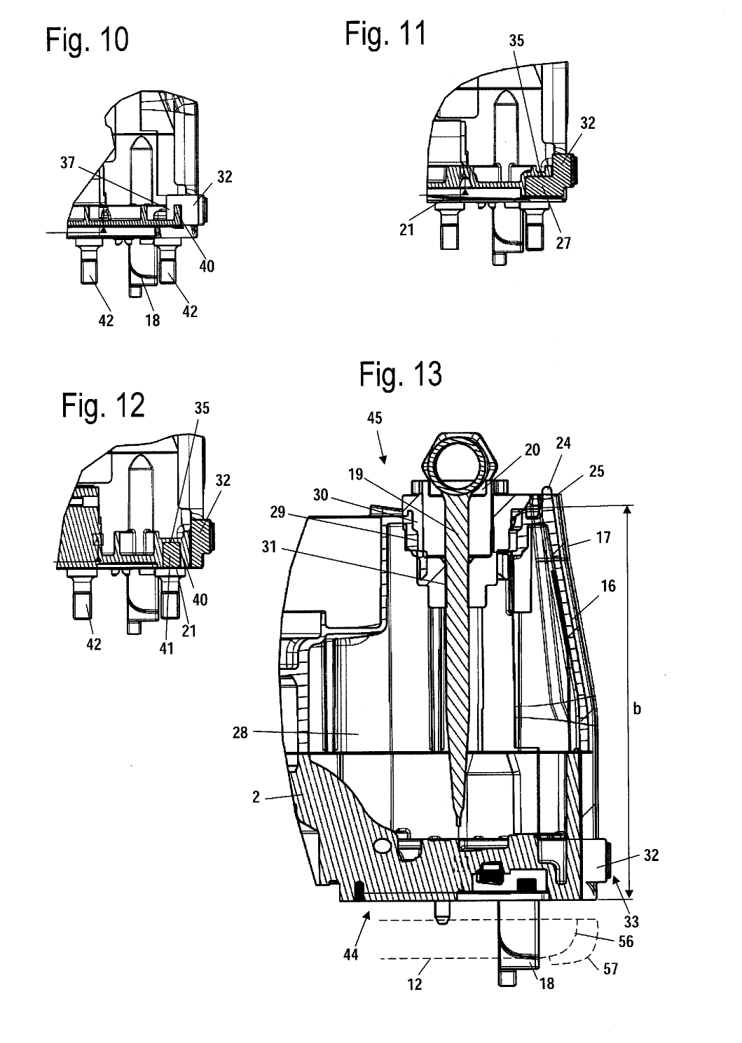

FIGS. 10 to 12 further illustrate the form-fitting fixation of the guard 17 in the area of the guide bar 9. As FIG. 10 shows, the securing section 37 engages around the housing wall 40 on the side facing away from the longitudinal side 44. As FIGS. 10 and 11 show, the holding sections 27 lie in depressions 35 which are open toward the longitudinal side 44. The holding sections 27 are thus inserted into the depressions 35 from the side opposite the securing section 37. As FIGS. 11 and 12 also show, the depressions 35 are covered by the side plate 21.

As FIG. 13 shows, the guard 17 extends over the entire width (b) of the housing front end 16 of the housing 2, the width (b) being measured perpendicular to the plane of the guide bar 9. As FIG. 13 also shows, the housing protrusion 24, which is formed on the housing 2, projects through the cutout 25 and extends beyond the guard 17 by a small amount. The guard 17 is exclusively held on the longitudinal sides 44 and 45 of the housing 2 and not in the area of the housing front end 16. As a result, the guard 17 can be arranged in the area of the housing front end 16 at a small distance from the housing front end 16 and support itself on the housing front end 16 exclusively via the ribs 39 (FIG. 8). The chain sprocket cover 12 is schematically indicated in FIG. 13. An additional guard 57 can be arranged on the chain sprocket cover, the guard 57 advantageously extending over the entire front end 56 of the chain sprocket cover 12 which faces the workpiece during operation and is adjacent to the workpiece. The front end 56 of the chain sprocket cover is also shown in FIG. 1.

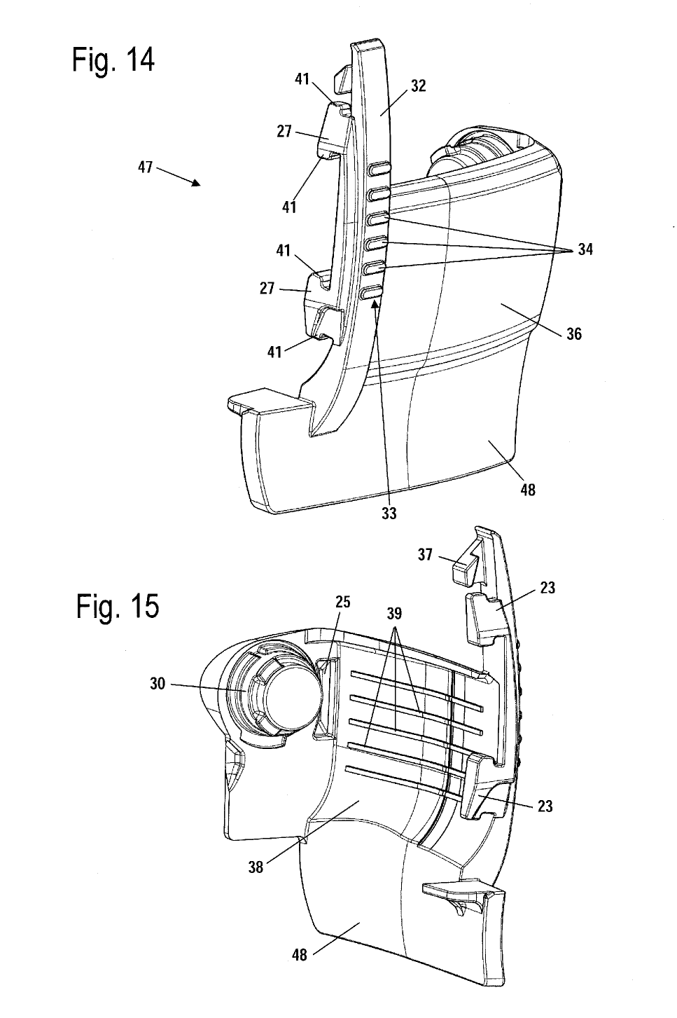

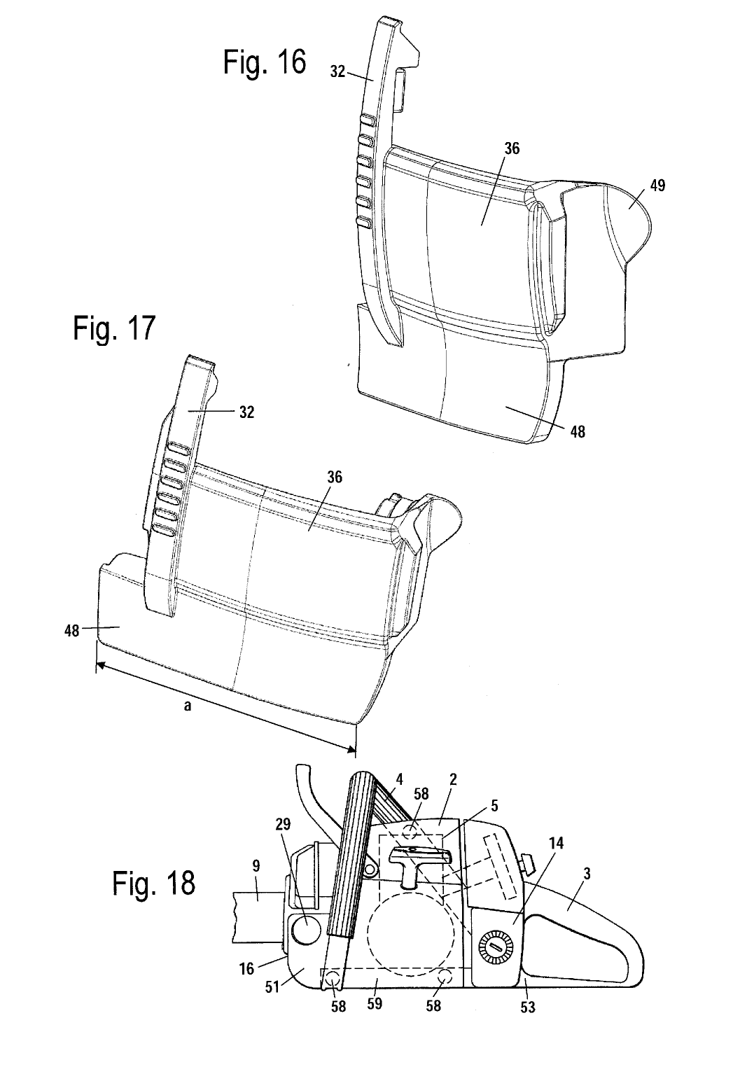

FIGS. 14 to 17 show an embodiment of a guard 47 which differs from the guard 17 substantially by way of the omitted retainer 20 for a tool 19. The guard 47 furthermore has a spray guard section 48 which is extended in relation to the spray guard section 18 of the guard 17 up to the side of the guard and on which the plug 30 and the recess 25 are arranged. The spray guard section 48 thus extends over the entire width (b) shown in FIG. 13 of the housing 2 and projects beyond the housing 2 of the stone cutter 1 on the longitudinal side 44 of the stone cutter 1. The width (a) of the spray guard section 48 is greater than the width (b) of the housing front end 16. The holding sections 27, the securing section 37, the supporting section 32 and the covering section 36 are essentially configured in a manner corresponding to the guard 17. The recess 25 in the guard 47 is not configured as an opening but rather as a depression, so that the housing protrusion 24 does not project out but is rather covered by the guard 47. As FIG. 16 shows, the guard 47 is configured in an essentially planar manner in the section on the outer side adjacent to the longitudinal side 44 of the housing 2. On the section of the guard 47 to be arranged on the longitudinal side 44 of the housing 2, a holding section 49, at which the operator can grip the guard 47 for assembly and disassembly, is formed in the region facing away from the housing front end 16. As a result, simple tool-free assembly and disassembly is possible.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a housing having a housing front end having a width (b);
a drive motor arranged in said housing;
a tool for cutting at least one of mineral materials and metal materials;
said housing front end being configured to face a workpiece to be cut and to be arranged adjacent to the workpiece during a cutting process;
said tool being disposed so as to project beyond said housing front end;
an elastic guard arranged on said housing front end and extending over at least 50% of said housing front end.

2. The work apparatus of claim 1, wherein said guard extends over at least 80% of said width (b) of said housing front end.

3. The work apparatus of claim 2, wherein said guard extends over the entirety of said width (b) of said housing front end.

4. The work apparatus of claim 3, wherein said housing front end defines a surface; and, said guard extends over all of said surface of said housing front end.

5. The work apparatus of claim 3, wherein said guard completely covers said housing front end.

6. The work apparatus of claim 1, wherein said guard has a spray guard section which runs in an area below said tool.

7. The work apparatus of claim 1, wherein:
said housing has a first longitudinal side and a second longitudinal side arranged opposite one another; and,
said guard is held on said housing in a form-fitting manner on both said first and said second longitudinal sides.

8. The work apparatus of claim 1, wherein:
said guard has at least one holding section; and,
said guard is fixed on housing in a form-fitting manner by said holding section.

9. The work apparatus of claim 8, wherein:
said housing has a wall section; and,
said holding section has a strut configured to engage behind said wall section of said housing in the direction of said housing front end.

10. The work apparatus of claim 8, wherein:
said housing has a housing wall;
said guard has a securing section configured to engage around said housing wall on the side opposite said holding section.

11. The work apparatus of claim 8, wherein said work apparatus is a stone cutter and said tool includes a guide bar; and, a saw chain configured to be driven in circulation about said guide bar; and, said stone cutter further comprises a side element made of sheet metal and being arranged between said housing and said guide bar and arranged so as to cover said holding section.

12. The work apparatus of claim 1, wherein said work apparatus is a stone cutter and said tool includes a guide bar; and, a saw chain configured to be driven in circulation about said guide bar.

13. The work apparatus of claim 1, wherein:
said housing has a housing opening; and,
said guard is held in said housing opening in a form-fitting manner.

14. The work apparatus of claim 13, wherein said tool is a first tool; and, wherein said work apparatus further comprises a second tool; said guard forms a retainer for said second tool in the region of said housing opening; said housing defines an interior space; said housing opening forms an access into said interior space; and, said interior space is configured as a receiving space for a portion of said second tool.

15. The work apparatus of claim 1, wherein:
said guard has a supporting section for resting on the workpiece; and,
said support section has a profile formed thereon.

16. The work apparatus of claim 1, wherein:
said guard has an inner side which faces said housing; and,
said guard has at least one rib disposed on said inner side of said guard for resting on said housing front end.

17. The work apparatus of claim 1 further comprising:
at least one attachment part having a front end and configured to be fixed on said housing;
said front end of said attachment part being configured to face said workpiece to be cut during a cutting process and configured to be arranged so as to be adjacent said workpiece; and,
said elastic guard at least partially covers said front end of said attachment part.

18. The work apparatus of claim 17, wherein said attachment part is a chain sprocket cover.

19. The work apparatus of claim 1, wherein said guard is made of one of elastomer and rubber.
